(19) United States
(12) Patent Application Publication
(10) Pub. No.: US 2010/0019909 A1
(43) Pub. Date: Jan. 28, 2010

(54) SUCTION ATTACHED EAS TAG

(75) Inventors: Michael Norman, East Brunswick, NJ (US); Chester Kolton, Westfield, NJ (US); Jacob Strassburger, South Plainfield, NJ (US)

Correspondence Address: HOFFMANN & BARON, LLP, 6900 JERICHO TURNPIKE, SYOSSET, NY, 11791, US

(73) Assignee: B&G INTERNATIONAL, INC., Newark, NJ (US)

(21) Appl. No.: 12/510,565

(22) Filed: Jul. 28, 2009

Related U.S. Application Data
(60) Provisional application No. 61/084,001, filed on Jul. 28, 2008.

(51) Int. Cl. G08B 13/14

(52) U.S. Cl. 340/572.8

(57) ABSTRACT

An electronic tag housing which may be secured to variously configured containers, such as containers having curved surfaces. The housing could have a base and a cover overlying the base for support of a tag therebetween. A flexible suction cup is secured to the base, the suction cup has an upper surface and an opposed lower suction surface for suction attachment to the article surface. An adhesive is applied to the lower suction surface for additional attachment to the suction cup to the curved surface.

### CROSS REFERENCE TO RELATED APPLICATION:

This application claims priority to U.S. Provisional Patent Application No. 61/084,001 filed on Jul. 28, 2008, the contents of which are incorporated herein by reference in their entirety.

### FIELD OF THE INVENTION

The present invention relates to an electronic tag housing used to support an electronic tag. More particularly, the present invention relates to a housing, which supports an electronic tag and which may be secured to variously configured containers, such as containers having curved surfaces, using suction.

### BACKGROUND OF THE INVENTION

It is widely known to use electronic tags for various purposes. Electronic article surveillance (EAS) tags as well as radio frequency identification (RFID) tags are used for purposes such as tracking sales and shipments of products to which they are attached. They also may be used to provide theft deterrence to articles to which they are attached.

It is desirable to provide a single electronic tag housing, which may be easily applied to a variety of products with different shaped surfaces, such as cylinders of various sizes and both flat and curved surfaces. The efficient use of such electronic tags requires the tag to be securely attached to the desired article to prevent inadvertent or unauthorized removal therefrom. However, to function effectively in the retail market, it is desirable to have the tag be quickly and efficiently removed from the article so that the purchaser can remove the article from the purchased location, especially when the tags are used in combination with article surveillance.

It is, therefore, desirable to provide an electronic tag housing of this type, which can easily be manufactured and applied, yet remain securely attached.

### SUMMARY OF THE INVENTION

The present invention provides an electronic tag housing assembly for attaching to an article surface. The assembly includes a housing, having a base and a cover overlying the base for support of a tag therebetween. A suction cup is secured to the base having an upper surface and an opposed lower suction surface for suction attachment to the article surface, and an adhesive is applied to the lower suction surface.

The present invention further provides a combination of an article with an article surface, a housing, an electronic tag supported within the housing, and a suction cup. The housing includes a base and a cover. The cover overlies the base and supports the tag therebetween. The suction cup is secured to the base. The suction cup has an upper surface and an opposed lower surface for suction attachment to the article surface. The lower suction surface includes an adhesive thereon for adhesively securing the lower suction surface to the article surface.

### BRIEF DESCRIPTION OF THE DRAWINGS

FIGS. 1A, 1B, and 1C shows an exploded perspective view of the components of the electronic tag housing assembly of the present invention.

FIGS. 2A, 2B, 2C, and 2D show isometric, side, top, and bottom views of the electronic tag housing assembly fully assembled.

FIGS. 3A, 3B, and 3C show a front, a side, and an enlarged view of the electronic tag housing assembly attached to a compressed gas cylinder.

FIG. 4 shows the electronic tag housing assembly attached to a box.

### DETAILED DESCRIPTION OF THE PREFERRED EMBODIMENT

The present invention provides a tag housing assembly including a housing, which supports an electronic tag, for example, an electronic article surveillance (EAS) tag or radio frequency identification (RFID) tag. The housing is attachable to an article so as to maintain the tag with the article to track shipment, purchase and/or to provide theft deterrence.

The tag housing assembly of the present invention supports a flexible suction cup, which may be suction attached to an article. The suction cup enables the housing to be attached to a variety of containers including both curved and flat containers. While the housing may be used in combination with any desired article, the present invention is particularly useful with articles having curved surfaces, such as compressed gas cylinders.

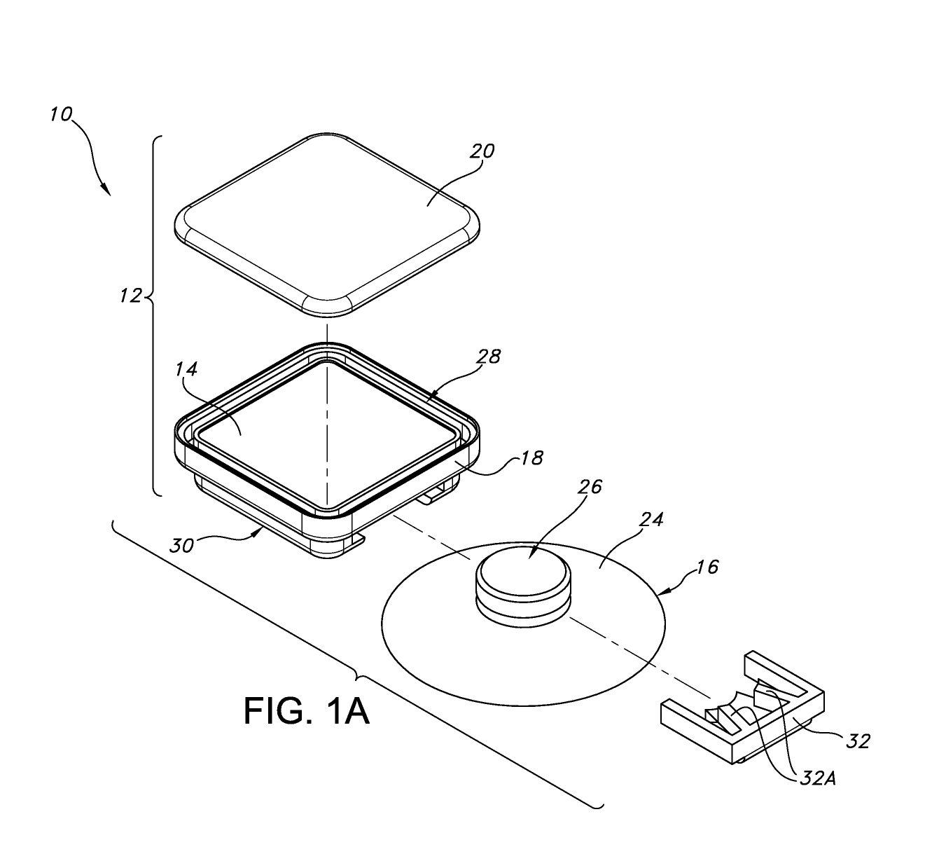

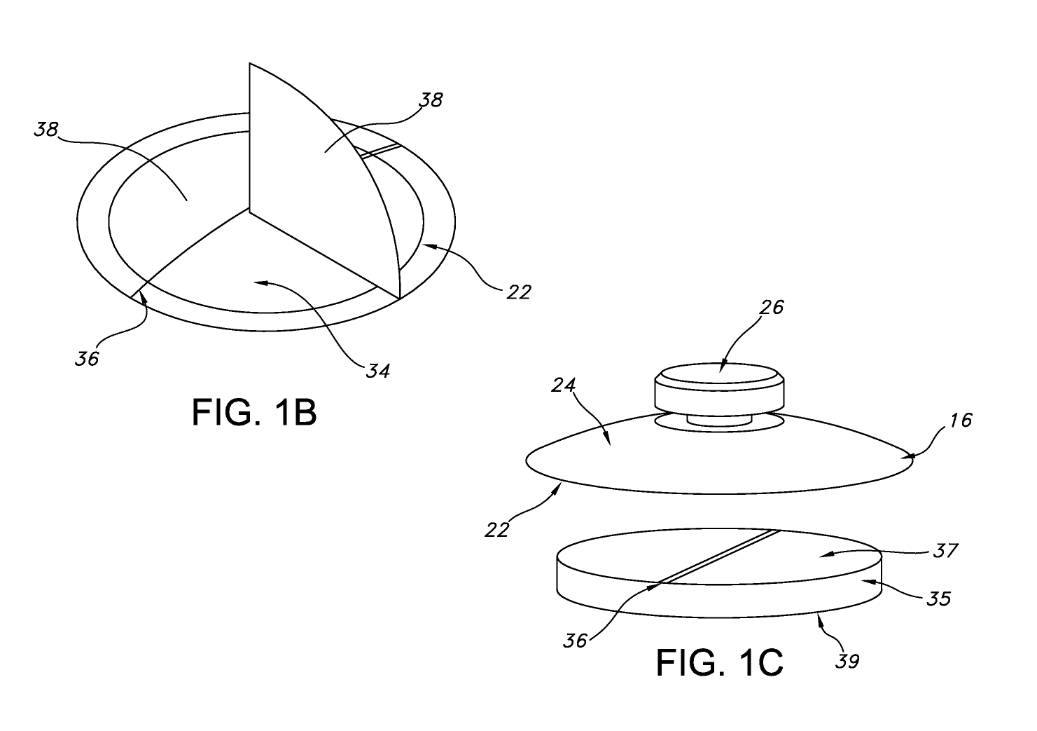

FIGS. 1A and 1B show the components of a tag housing assembly 10. With reference to FIG. 1A, the tag housing assembly 10 of the present invention includes a housing 12, an electronic tag 14, and a suction cup 16. The housing 12 further includes a base 18 and a cover 20 overlying the base 18 to support the tag 14. The suction cup 16 includes a lower suction surface 22 that attaches to an article and an upper surface 24 with a post 26 to receive the housing 12.

In the present embodiment, the tag 14 is a generally planar member, which may function as an EAS tag or an RFID tag, as is well known in the art. Other configurations and types of electronic tags 14 are also contemplated within the scope of the present invention.

The tag housing 12 is generally a planar shaped two-piece member including the base 18 and the cover 20. The base 18 may include a cavity 28 formed therein. The cavity 28 is configured to accommodate the tag 14 therein. The cover 20 is positionable over the base 18 and is attached thereto to cover and enclose the tag 14 within the cavity 28 of the base 18. The cover 20 is attached to the base 18 by any well known attachment technique, such as friction fit, adhesive, sonic welding, and the like.

The base 18 includes a suction cup catch 30 that attaches the base 18 to the suction cup 16 using the post 26 located on the upper surface 24 of the suction cup 16. The catch 30 is attached to the base 18 by any well known attachment technique, such as friction fit, adhesive, sonic welding, and the like. It is contemplated however, that the catch 30 may also be integrally formed with the base 18. A suction cup lock 32 is configured for engagement with the catch 30 and used to secure the post 26 to the base 18. Preferably, the lock 32 is attached to the catch 30 in a non-removable fashion. For example, the lock 32 may include one way spring fingers 32a that engage with a mating structure (not shown) on the catch 30 to non-removably secure the lock 32 to the catch 30.

FIG. 1B, shows a lower surface of the suction cup 16. The lower surface 22 of the suction cup 16 contains an adhesive 34 to securely attach the housing assembly 10 to an article surface. In a preferred embodiment shown in FIGS. 1A and 1B a coating of the adhesive 34 is applied directly to the lower surface 22 of the suction cup 16 with a removable release strip 36 and a protective film 38 overlaying the adhesive 34. When the release strip 36 and the protective film 38 are removed from the lower suction surface 22, the suction cup 16 may be attached to the article surface by the suction cup 16 and secured by the adhesive 34. The adhesive 34 may include any variety of well known adhesives 34.

The invention also contemplates using a separately applied adhesive 34, such as a two sided disc 35, with the removable release strips 36 and the protective film 38 on both sides of the disc 35, as shown in FIG. 1C. The two sided disc 35 may include a first side 37 of the disc 35 for adhesive attachment to the lower suction surface 22 and a second side 39 of the disc 35 for adhesive attachment to the article surface.

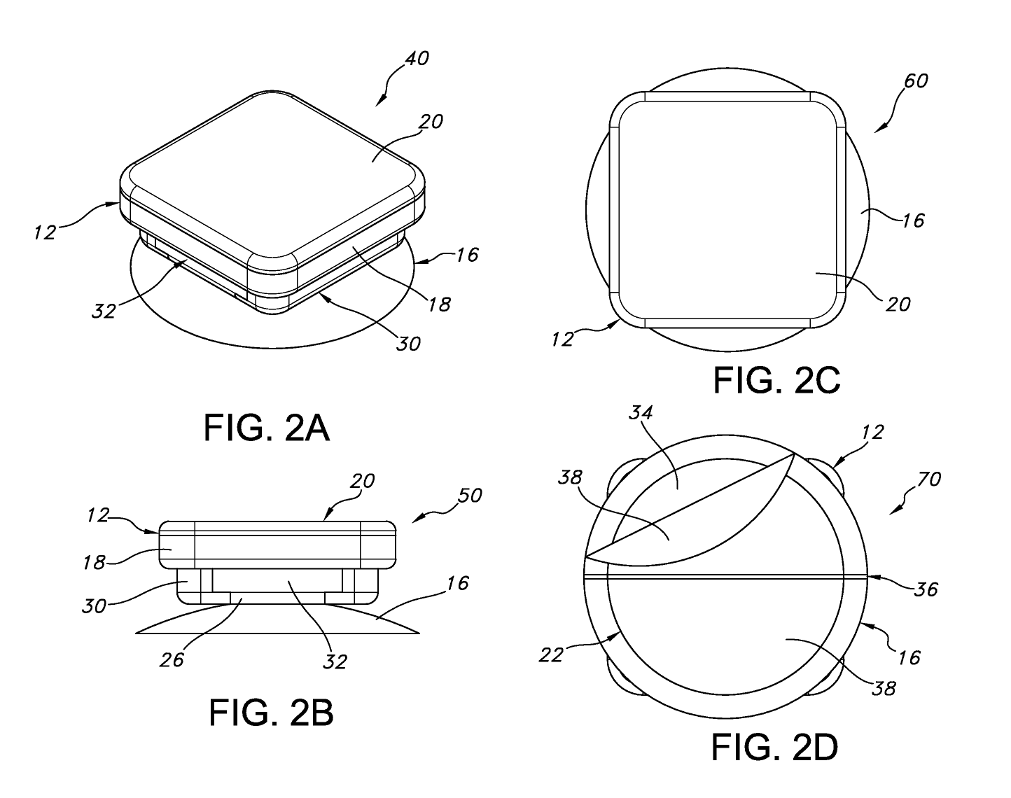

Referring to FIGS. 2A-2D, the electronic tag housing assembly 10 is more fully shown. FIG. 2A shows an isometric view 40 of the tag housing assembly 10 with the housing 12 assembled and attached to the suction cup 16. FIG. 2B shows the side view 50 of the tag housing assembly 10 with the suction cup lock 32 visible. A top view 60 of the tag housing assembly 10 is shown in FIG. 2C. FIG. 2D shows a bottom view 70 of the tag housing assembly 10 with the adhesive 34, the release strip 36, and the protective film 38 on the lower surface 22 of the suction cup 16.

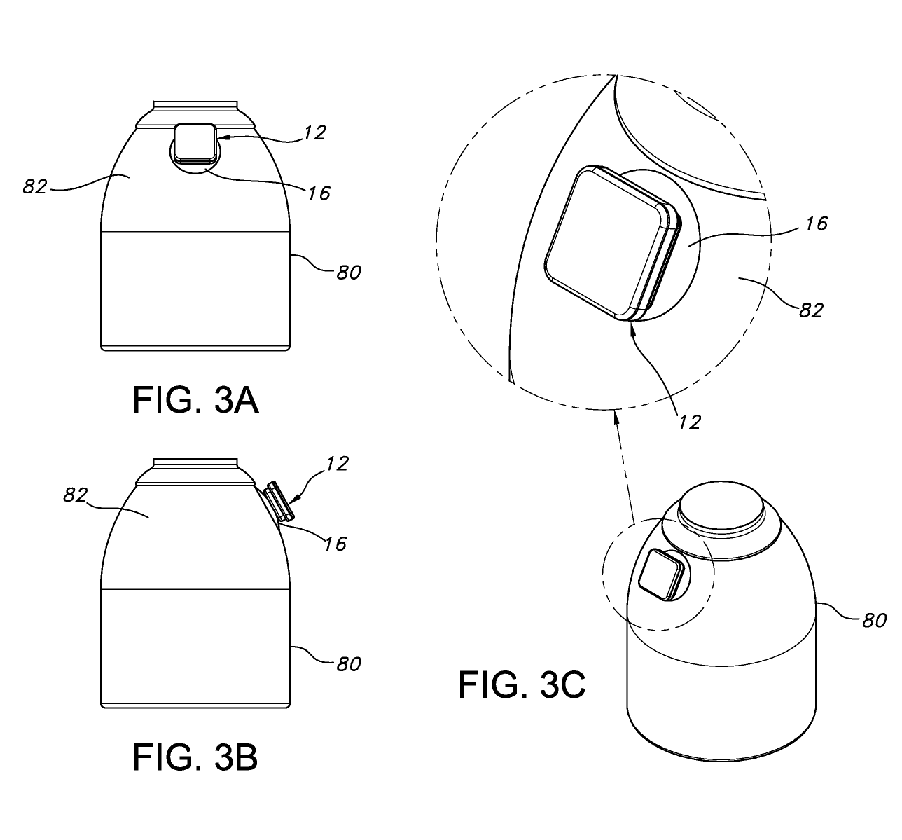

FIGS. 3A-3C show the electronic tag housing assembly 10 attached to a compressed gas cylinder 80, having a non-flat or curved article surface 82. In one embodiment of the present invention, the tag housing assembly 10 is attached to the curved article surface 82 by removing the release strip 36 and the protective film 38 that covers the adhesive 34 on the lower suction surface 22, attaching the suction cup 16 to the curved article surface 82, and securing the tag housing assembly 10 to the curved article surface 82 by both suction and adhesion. This embodiment shows the flexible nature of the suction cup 16 which allows it to conform to the curved surface of the cylinder 80. While a suction attachment is achieved between the suction cup 16 and the curved article surface 82 of the cylinder 80, the primary attachment is by adhesive attachment of the suction cup 16 to the cylinder 80.

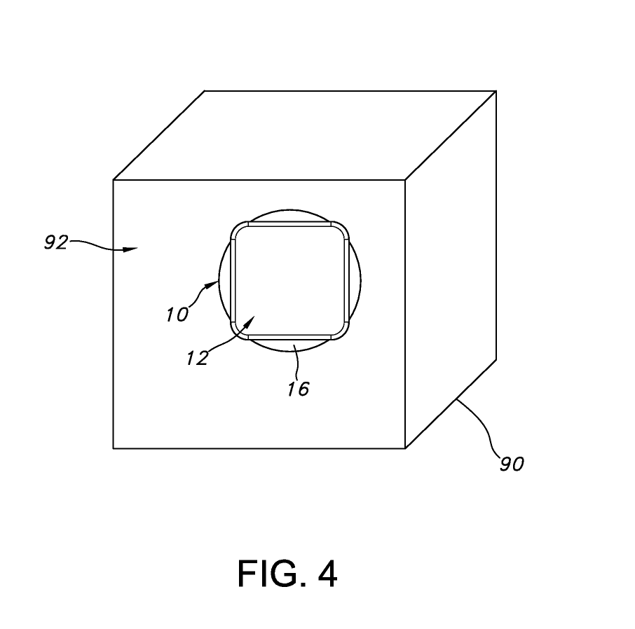

FIG. 4 shows a further embodiment of the electronic tag housing assembly 10 attached to a box 90, having a flat article surface 92. In one embodiment, the tag housing assembly 10 is attached to the flat article surface 92 using a two sided disc 35. First, the release strip 36 and the protective film 38 are removed from the first side 37 of the disc 35 and the first side 37 of the disc 35 is attached to the lower suction surface 22. Then, the release strip 36 and the protective film 38 are removed from the second side 39 of the disc 35 and the second side 39 of the disc 35 is attached to the flat article surface 92 by both suction and adhesion.

The present invention further allows authorized personnel to remove the tag housing assembly 10 from the product by removing the lock 32 from the catch 30 and separating the suction cup 16 and the housing 12.

Various changes to the foregoing described and shown structures would now be evident to those skilled in the art. Accordingly, the particularly disclosed scope of the invention is set forth in the following claims.

What is claimed is:

1. An electronic tag housing assembly for attaching to an article surface comprising:
a housing;
an electronic tag supported within said housing;
said housing including:
a base;
a cover overlying said base and supporting said tag therebetween; and
a flexible suction cup secured to said base, said suction cup having an upper surface and an opposed lower surface for suction attachment to said article surface, said lower suction surface includes an adhesive thereon for adhesively securing said lower suction surface to said article surface.

2. An electronic tag housing assembly of claim 1, wherein said base and said cover define a cavity therebetween for support of said tag.

3. An electronic tag housing assembly of claim 1, wherein said upper surface of said suction cup includes a projecting post, said post being secured to said base of said housing.

4. An electronic tag housing assembly of claim 3, wherein said base of said housing further includes a suction cup catch configured to receive said post of said suction cup.

5. An electronic tag housing assembly of claim 4, wherein said catch is attached to said base using sonic welding.

6. An electronic tag housing assembly of claim 4, wherein said housing further includes a suction cup lock configured to engage with said catch and secure said post of said suction cup to said base.

7. An electronic tag housing assembly of claim 1, wherein said base and said cover form a hermetic seal.

8. An electronic tag housing assembly of claim 7, wherein said cover is attached to said base using sonic welding.

9. An electronic tag housing assembly of claim 1, wherein said tag is selected from the group consisting of an article surveillance tag and a radio frequency identification tag.

10. An electronic tag housing assembly of claim 1, wherein said adhesive is applied as a coating to said lower suction surface.

11. An electrical tag housing assembly of claim 1, wherein said adhesive is a two-sided disc configured to adhesively attach to said lower suction surface and said article surface.

12. In combination:
an article, having an article surface;
a housing including a base and a cover, said cover overlying said base
an electronic tag supported within said housing; and
a flexible suction cup secured to said base, said suction cup having an upper surface and an opposed lower surface for suction attachment to said article surface, said lower suction surface includes an adhesive thereon for adhesively securing said lower suction surface to said article surface.

13. The combination of claim 12, wherein said article surface is curved.

14. The combination of claim 12, wherein said article surface is flat.

15. The combination of claim 12, wherein said suction cup includes a projecting post, said post being secured to said base of said housing.

16. The combination of claim 15, wherein said base of said housing further includes a suction cup catch configured to receive said post of said suction cup.

17. The combination of claim 16, wherein said catch is attached to said base using sonic welding.

18. An electronic tag housing assembly of claim 17, wherein said housing further includes a suction cup lock configured to engage with said catch and secure said post of said suction cup to said base.

19. The combination of claim 12, wherein said tag is selected from the group consisting of an article surveillance tag and a radio frequency identification tag.

20. The combination of claim 12, wherein said adhesive is applied as a coating to said lower suction surface.

21. The combination of claim 12, wherein said adhesive is a two-sided disc configured to adhesively attach to said lower suction surface and said article surface.
